(19) United States
(12) Patent Application Publication
(10) Pub. No.: US 2006/0229923 A1
(43) Pub. Date: Oct. 12, 2006

(54) Definition of workflow patterns using complex event processing

(75) Inventors: Asaf Adi, Kiryat Ata (IL); Koby Hadash, Kiryat Bialik (IL); Oren Kerem, Stanford, CA (US); Gil Nechushtai, Haifa (IL); David Oren, Haifa (IL); Boris Shulman, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/093,572

(22) Filed: Mar. 30, 2005

(51) Int. Cl. G05B 19/418

(52) U.S. Cl. 705/8; 718/100

(57) ABSTRACT

A method for workflow management includes modeling a workflow as a set of nodes linked by transitions. At least one of the nodes is defined as an action triggered by a situation using a complex event processing (CEP) engine. During execution of the workflow, the CEP engine is invoked in order to detect the situation, and the action is performed responsively to detection of the situation by the CEP engine.

### FIELD OF THE INVENTION

The present invention relates generally to workflow management, and specifically to modeling of workflow patterns.

### BACKGROUND OF THE INVENTION

Businesses use workflow management to understand the processes carried out within their organizations, in order to improve efficiency and quality and to reduce costs. Workflow management systems typically use a visual model of information flow for purposes of monitoring and managing the business processes within an organization. In the context of the present patent application and in the claims, a “process” is defined as a set of activities, also known in the art as tasks, together with transitions (constraints on execution order, also referred to as the “control flow”) among these activities. Typically, processes are modeled as directed graphs, having nodes representing individual activities and edges representing the transitions among the activities.

A variety of languages and tools have been developed for modeling and monitoring workflow processes. One example is the WebSphere® MQ Workflow system, which is distributed by IBM Corp. (Armonk, N.Y.). The system is described at www-306.ibm.com/software/integration/ wmqwf/.

Van der Aalst et al. analyze a variety of workflow management tools in a paper entitled “Workflow Patterns,” CITI Technical Report FIT-TR-2002-02 (Centre for Information Technology Innovation, Brisbane, Australia, 2002), which is incorporated herein by reference. This paper is available at www.citi.qut.edu.au/about/research_pubs/technical/workflow_patterns.pdf. The authors define and categorize workflow patterns that describe basic workflow functionalities. The definitions are independent of the specific semantic constructs that are used to express these patterns in the different workflow management tools that are analyzed in the article. A “workflow pattern” in this context denotes a certain generic business scenario, involving a set of activities and the transitions among these activities.

The twenty different patterns defined by van der Aalst et al. range from basic control flow patterns, such as “Sequence” (an activity in a workflow process is enabled after the completion of another activity in the same process), to structural patterns, such as “Arbitrary Cycles” (i.e., loops in the control flow), and patterns involving multiple instances of the same activity or sub-process running simultaneously. The authors point out that although existing workflow management languages generally cover all the basic patterns, many of the more complex patterns are not well-supported. As a result, users of workflow management systems have difficulty in accurately modeling processes that involve complex patterns.

U.S. Pat. No. 6,604,093, whose disclosure is incorporated herein by reference, describes a situation awareness system. The system uses a language that enables complex events to be defined as the composition of multiple simple events, for example, successive withdrawals from one or more bank accounts. In addition, a particular order and other timing constraints on the component events may be specified. Once the complex event has been detected, there may be one or more conditions that qualify the event, for example, that the amounts of the withdrawals be greater than a specified threshold. If the conditions are satisfied, then an action is triggered, such as alerting the bank's security manager of a possible fraud. The patent defines a specified composition of events together with the conditions attached to these events as a “situation.” The present patent application uses this definition, as well.

The situation management system described in U.S. Pat. No. 6,604,093 provides tools for defining intervals during which a given situation is meaningful and for detecting and reacting to the occurrence of the situation during such intervals. An interval of this sort is referred to as a “lifespan.” A lifespan begins with an initiating event, or initiator, and ends with a terminating event, or terminator. The situation management system enables manipulation of the initiator and terminator, such as by attachment of conditions to the initiating and terminating events. The situation management system also defines quantifiers, indicating how the system is to respond to repeated occurrences of a given event in a given lifespan.

Aspects of the situation management system described in U.S. Pat. No. 6,604,093 are implemented in AMiT, a situation management tool developed at IBM Haifa Research Laboratory (Haifa, Israel). AMiT is described in an article by Adi and Etzion entitled, “AMiT—the Situation Manager,” VLDB Journal 13(2) (Springer-Verlag, May, 2004), pages 177-203, which is incorporated herein by reference.

U.S. Patent Application Publication US 2003/0154115, whose disclosure is incorporated herein by reference, describes an event-driven workflow system. A job enters the workflow system by having its status set to the first possible status value. Setting or updating status triggers an event, which signals a worker process associated with the status to process the job. After the job is processed, the worker process updates the status to an output status which triggers another event signal to another worker process associated with the output status to proceed with processing the job. In this way, a change in the status of the job drives the workflow environment to provide a just-in-time type system for processing jobs using database technology.

U.S. Patent Application Publication US 2003/0233374, whose disclosure is incorporated herein by reference, describes a system for creating and altering a dynamic workflow process during runtime and executing the runtime-built or modified workflow. Users can thus make ad hoc custom workflows and change workflows on the fly in response to special requirements of a given situation. A graphical tree editor is employed for runtime manipulation of the process definition.

### SUMMARY OF THE INVENTION

In embodiments of the present invention, a complex event processing (CEP) engine is integrated with a workflow management system. The CEP engine is used to define new types of nodes within the workflow, which express complex, event-driven workflow patterns. Typically, the nodes correspond to CEP-based activities, which are modeled as an action driven by a corresponding situation (as defined in U.S. Pat. No. 6,604,093, cited above). When the situation is detected, an event indication is triggered, which causes the action to be executed. The CEP-based activities may be external to the workflow management system. Alternatively, the CEP engine may be used to implement built-in constructs or other types of built-in nodes within the workflow management system.

Implementation of the CEP features at the activity level in some embodiments of the present invention permits these embodiments to be integrated easily into both new and existing workflow management tools. Addition of CEP capabilities in this manner permits the workflow designer to define a complex pattern externally, and then to import the pattern into the workflow management tool even when the semantics of the tool itself do not support patterns of this sort. Furthermore, when patterns are implemented by the CEP engine, the designer may change the patterns without recompiling the entire workflow, and may even change the patterns dynamically while the workflow is running.

There is therefore provided, in accordance with an embodiment of the present invention, a method for workflow management, including:

modeling a workflow as a set of nodes linked by transitions;

defining at least one of the nodes as an action triggered by a situation using a complex event processing (CEP) engine;

during execution of the workflow, invoking the CEP engine in order to detect the situation; and

performing the action responsively to detection of the situation by the CEP engine.

Typically, defining the at least one of the nodes includes modeling a complex pattern including a scenario involving a set of activities and the transitions among the set of the activities. Modeling the complex pattern may include changing the pattern, using the CEP engine, during execution of the workflow.

In some embodiments, defining the at least one of the nodes includes defining a lifespan of the situation including initiating and terminating events and a condition for triggering the action during the lifespan. Typically, performing the action includes detecting the initiating event, and triggering the action using the CEP engine if the condition is fulfilled during the lifespan. In disclosed embodiments, defining the at least one of the nodes includes defining at least one of a deferred choice pattern and a milestone pattern.

In another embodiment, defining the at least one of the nodes includes defining a loop in the workflow including a conditional XOR-Split having a condition associated therewith, and performing the action includes applying the CEP engine to determine whether to repeat or exit the loop responsively to the condition.

Additionally or alternatively, defining the at least one of the nodes includes defining the situation as a composition of multiple subsidiary situations, each of which triggers a corresponding action, and performing the action includes detecting one of the subsidiary situations using the CEP engine, and triggering the corresponding action.

There is also provided, in accordance with an embodiment of the present invention, apparatus for workflow management, including:

a modeling station, which is arranged to model a workflow as a set of nodes linked by transitions, in which at least one of the nodes is defined as an action triggered by a situation using a complex event processing (CEP) engine; and

a workflow server, which is arranged to execute the workflow while invoking the CEP engine in order to detect the situation, and to cause the action to be performed responsively to detection of the situation by the CEP engine.

There is additionally provided, in accordance with an embodiment of the present invention, a computer software product for workflow management, the product including a computer-readable medium in which program instructions are stored, which instructions, when read by a computer, cause the computer to model a workflow as a set of nodes linked by transitions, in which at least one of the nodes is defined as an action triggered by a situation using a complex event processing (CEP) engine, and to execute the workflow while invoking the CEP engine in order to detect the situation, and to cause the action to be performed responsively to detection of the situation by the CEP engine.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a workflow management system, in accordance with an embodiment of the present invention;

FIG. 2 is a block diagram that schematically illustrates a workflow graph comprising a complex workflow pattern, in accordance with an embodiment of the present invention;

FIG. 3 is a block diagram that schematically shows details of a complex workflow pattern, in accordance with an embodiment of the present invention; and

FIGS. 4-6 are block diagram that schematically illustrate other complex workflow patterns, in accordance with embodiments of the present invention.

### DETAILED DESCRIPTION OF EMBODIMENTS

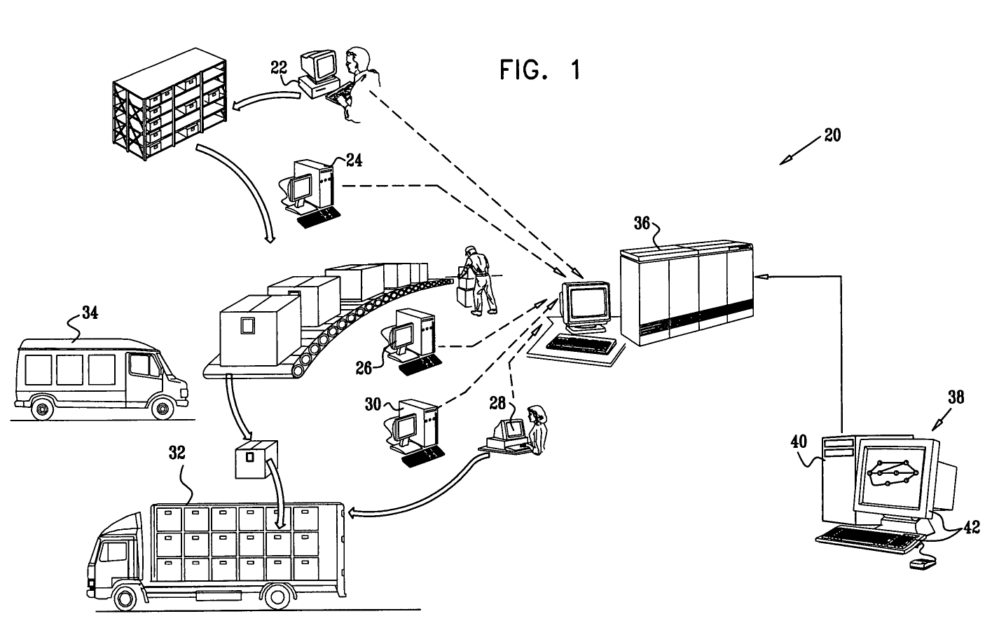

FIG. 1 is a schematic, pictorial illustration showing a system 20 for workflow management of a business process, in accordance with an embodiment of the present invention. By way of example, a typical production process is shown on the left side of the figure, using a network of computers to carry out and track the process within the enterprise. Inventory orders are placed through a purchasing workstation 22, following which inventory is tracked and moved into production using an inventory control workstation 24. A production control workstation 26 tracks the assembly of finished goods. A sales workstation 28 is used in receiving and fulfilling customer orders, while a shipping workstation 30 monitors transfer of the finished goods to a carrier for shipment. Two different shipping options are available, shown as carriers 32 and 34.

Each of workstations 22, 24, . . . , 30 reports each step or transaction it performs to a workflow server 36. The server tracks and controls the business process based on a workflow model prepared by a modeling station 38. The modeling station typically comprises a general-purpose computer workstation, with a processor 40 and user interface 42, which enables a workflow designer to create and edit the process model. Although modeling station 38 is shown in the figures as a separate unit from server 36, in practice the modeling station may simply comprise user interface 42, and the functions of processor 40 may be integrated into the server. Server 36 and processor 40 are programmed with suitable software for this purpose, including workflow modeling and management software, such as the above-mentioned MQ Workflow package, with the addition of a complex event processing (CEP) engine for creating situation-driven activities, as described in detail hereinbelow. The software for this purpose may be provided to server 36 and modeling station 38 in electronic form, over a network, for example, or it may alternatively be furnished on tangible media, such as optical, magnetic or electronic memory media.

Each activity in the workflow model may comprise not only an action, but also a corresponding situation, as defined in the Background of the Invention. When workflow server 36 detects that the situation has been triggered (i.e., that the prescribed combination of events has taken place, subject to the required conditions), it causes the action to be executed. Execution of the action triggers a corresponding execution status event, containing a “status” attribute. This attribute indicates whether the execution succeeded or failed and may contain other information regarding the result of the activity. If the situation is not detected as the result of an unsatisfied condition, the execution status event may be triggered with the status attribute “not_executed.”

Based on this situation-driven workflow model, transitions in the workflow may be modeled as event flows. In other words, assuming that a given activity triggers some event, the next activity in the workflow will receive the triggered event as an operand. To support this sort of model, internal events in the workflow may have a transaction_id attribute. Lifespans of situations in the workflow activities are then keyed by the transaction_id, so that each workflow instance is identified by the transaction_id of the global workflow transaction. In this manner, multiple instances of the same workflow may run simultaneously, while the lifespans associated with the different workflows are distinguished from one another.

The figures that follow show a number of examples of implementation of workflow patterns in system 20, using the combination of workflow modeling and CEP tools described above. These patterns are shown here solely as an illustration of the capabilities of this combination. Models of other workflow patterns using CEP, based on the principles of the present invention, will be apparent to those skilled in the art based on the description given herein and are considered to be within the scope of the present invention.

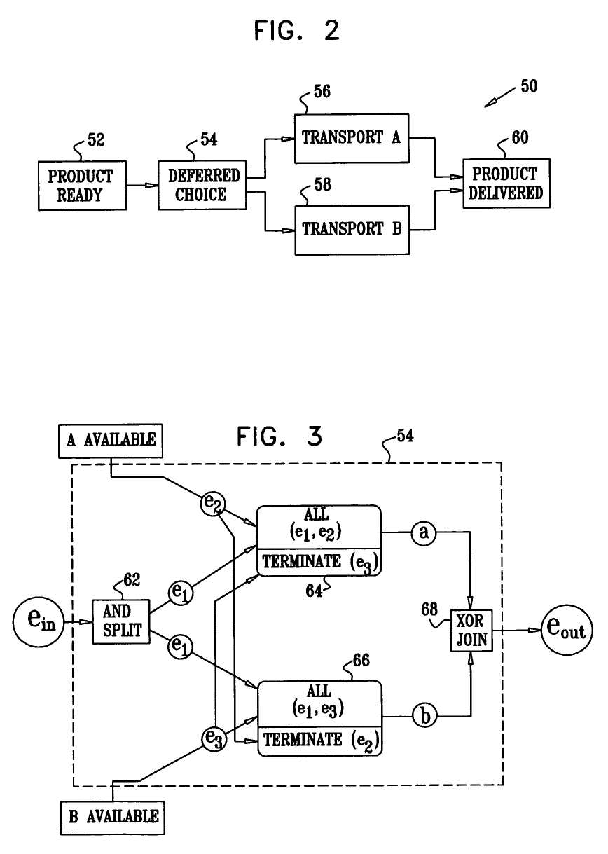

FIG. 2 is a block diagram that schematically illustrates a sample workflow graph 50, in accordance with an embodiment of the present invention. This graph relates to a part of the exemplary workflow shown in FIG. 1. The workflow model is constructed and executed using the CEP capabilities of station 38 and server 36. In this workflow, a “product ready” activity 52 is completed when workstation 26 indicates to server 36 that a product is ready for shipment. The workflow then branches to one of two alternative activities: a “transport A” activity 56, corresponding to shipment by carrier 32, or a “transport B” activity 58, corresponding to shipment by carrier 34. The choice between activities 56 and 58 depends on the availability of resources to perform the activity, i.e., the availability of either carrier 32 or carrier 34 to make the shipment. In other words, the choice is not made immediately upon completion of activity 52, but is rather deferred until one of the resources actually becomes available.

The choice of which carrier to use is thus made by a “deferred choice” activity 54, which is executed by means of a call to the CEP engine. “Deferred choice” is one of the patterns that was identified in the above-mentioned paper by van der Aalst et al. and was found to be poorly supported by workflow management tools known in the art. In contrast to a simple XOR-split (in which one alternative is chosen), the deferred choice is not made explicitly based simply on data or a decision. Rather, several alternatives are offered to the process environment. In contrast to an AND-split, however, in which multiple branches are executed, only one of the alternatives is executed after a deferred choice. Therefore, once the environment activates one of the branches, the other alternative branches are withdrawn. The choice is delayed until the processing in one of the alternative branches is actually started, i.e., the moment of choice is typically as late as possible. In the present example, once activity 56 is chosen, activity 58 is withdrawn. Execution then proceeds to completion of the process, at a product delivery activity 60.

FIG. 3 is a block diagram that schematically shows details of deferred choice activity 54, in accordance with an embodiment of the present invention. Completion of product ready activity 52 generates an initiating event ein, which triggers an AND-split node 62 in activity 54. The AND-split generates an event e₁, which initiates the lifespans of situations 64 and 66. In the example described above, situation 64 drives the choice of transport A activity 56, while situation 66 drives the choice of transport B activity. Situation 64 triggers an execution event a if and when transport A becomes available during the lifespan of situation 64, whereas situation 66 triggers an execution event b if and when transport B becomes available during the lifespan of situation 66.

In terms of CEP semantics (as used in the above-mentioned AMiT CEP tool), availability of transport A generates an event e₂, and availability of transport B generates an event e₃. Situation 64 can be expressed as ALL(e₁,e₂), while situation 66 is expressed as ALL(e₁,e₃). The ALL operator means that the respective situation is detected (and the execution event is generated) if the operand events arrive in any order during the lifespan of the situation. To dictate that only one of the two transport options is actually chosen, e₂ terminates the lifespan of situation 66, and e₃ terminates the lifespan of situation 64. Thus, whichever transport option becomes available first causes the corresponding situation to choose the available transport option and causes the situation corresponding to the alternative transport option to terminate without execution. An XOR-join node 68 completes activity 54 with an output event eout upon triggering of either event a or event b.

Although the deferred choice activity of FIG. 3 is described hereinabove with reference to a particular type of deferred choice, the pattern of deferred choice may similarly be applied in other sorts of business processes, such as the examples given by Van der Aalst. These examples include choosing between processing an insurance claim and performing a quality assurance audit (when audit resources are available); and requesting approval of a business expense from two alternative approval channels, one of which is sufficient to approve the expense. The activity structure shown in FIG. 3 is applicable as a paradigm to any instance of the deferred choice pattern.

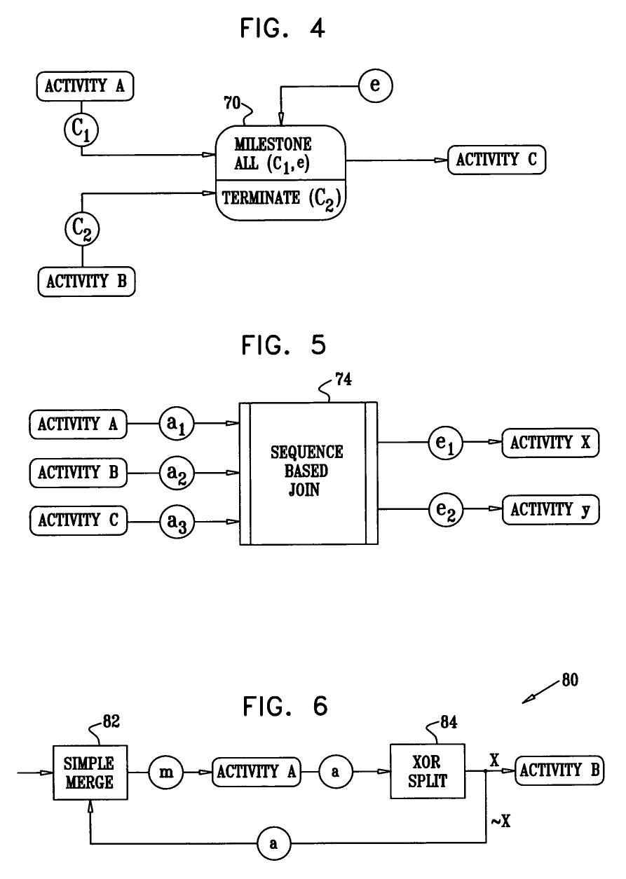

FIG. 4 is a block diagram that schematically shows details of a milestone activity 70, in accordance with an embodiment of the present invention. In the milestone pattern (also described by van der Aalst), an activity is enabled only if a certain milestone has been reached and has not yet expired. For example, FIG. 4 shows three activities named A, B, and C. Activity C is enabled only if activity A has been executed and Activity B has not yet occurred. Event e triggers activity C if it is enabled. Examples of this pattern include the following:
In a travel agency, flights, rental cars, and hotels may be booked as long as the invoice is not printed.
A customer can withdraw purchase orders until two days before the planned delivery.
A customer can claim air miles until six months after the flight.

In CEP terms, the milestone situation embodied in activity 70 is expressed as ALL(c₁,e), wherein c₁ is the completion event of activity A. The milestone lifespan is terminated by completion event c₂ of activity B. Activity C is triggered by the milestone situation. Alternatively, activity C itself may be composed as a complex activity, incorporating the characteristics of milestone activity 70.

FIG. 5 is a block diagram that schematically shows details of a sequence-based join activity 74, in accordance with an embodiment of the present invention. Activity 74 synchronizes multiple parallel sub-processes in a workflow into a single thread of control, and then selects one subsequent activity on the basis of the order of completion of the preceding activities. In the present example, activity 74 synchronizes sub-processes that culminate in activities A, B and C (which generate execution status events a₁, a₂ and a₃, respectively), and then selects one of subsequent activities X and Y by generating event e₁ or e₂. In other words, activity 74 performs an AND-join of activities A, B and C and a XOR-split between activities X and Y. The number of preceding and succeeding activities in this example is arbitrary, and the pattern embodied in activity 74 may have greater or lesser numbers of preceding and succeeding activities.

The sequence-based join situation of activity 74 is a composition of N different, parallel subsidiary situations, each corresponding to a different permutation of the events a₁, a₂ and a₃ (in this example N=6). In terms of AMiT CEP semantics, each situation is represented by the operator SEQUENCE(aᵢ,aⱼ,aₖ), wherein i, j and k take on the values 1, 2 and 3 in the appropriate order. Each of the subsidiary situations is detected when activity 74 receives execution status events from all of activities A, B and C, in the specified order. Thus, one (and only one) of the N situations receives the “execution_success” value. Each such situation references either event e₁ or e₂, based on knowledge programmed into the model by the workflow designer.

In another embodiment, not shown in the figures, a quantum multiple choice pattern similarly synchronizes multiple preceding sub-processes, but in this case chooses the next activity by alternating among the possible succeeding activities. The alternation may take place upon every pass through the quantum multiple choice activity or every N passes, N>1.

FIG. 6 is a block diagram that schematically shows details of a loop activity 80, in accordance with an embodiment of the present invention. This activity corresponds to the “Arbitrary Cycles” pattern defined by van der Aalst. In the present example, activity A (which may itself include a sequence of activities) is repeated an arbitrary number of times, until a condition X is fulfilled. A merge node 82 is placed at the start of the cycle in order to merge the incoming flow and the looping flow. At the end of the cycle, a XOR-split node 84 passes the flow to the next activity (in this case activity B) when condition X is fulfilled, or otherwise, on condition ˜X, returns the flow to the start of the cycle. This loop implementation enables GOTO-like behavior.

XOR-split node 84 can be implemented by defining condition X as a threshold on a parameter of status event a that is generated by activity A. If a is less than the threshold, for example, the XOR-split will loop back to merge node 82 (and may provide the status event as input to the next cycle). If a is greater than or equal to the threshold, the flow passes on to activity B. For example, a loop counter (not shown in the figure) may be incorporated in the loop, and the XOR-split may exit from the loop after a certain number of counts is reached. More generally, other stop conditions or exit points may be added to the loop, using appropriate CEP operators.

It will be understood that the particular patterns and CEP implementations described above are shown solely by way of example, to illustrate how a CEP engine may be used to generate different, complex patterns in a workflow design. Other CEP-based implementations of these patterns will be apparent to those skilled in the art. The principles and techniques embodied in the above examples may similarly be used to implement all of the other patterns described by van der Aalst, as well as additional patterns (such as the sequence-based join of FIG. 5) that are not suggested by van der Aalst.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for workflow management, comprising:
modeling a workflow as a set of nodes linked by transitions;
defining at least one of the nodes as an action triggered by a situation using a complex event processing (CEP) engine;
during execution of the workflow, invoking the CEP engine in order to detect the situation; and
performing the action responsively to detection of the situation by the CEP engine.

2. The method according to claim 1, wherein defining the at least one of the nodes comprises modeling a complex pattern comprising a scenario involving a set of activities and the transitions among the set of the activities.

3. The method according to claim 2, wherein modeling the complex pattern comprises changing the pattern, using the CEP engine, during execution of the workflow.

4. The method according to claim 1, wherein defining the at least one of the nodes comprises defining a lifespan of the situation comprising initiating and terminating events and a condition for triggering the action during the lifespan.

5. The method according to claim 4, wherein performing the action comprises detecting the initiating event, and triggering the action using the CEP engine if the condition is fulfilled during the lifespan.

6. The method according to claim 5, wherein defining the at least one of the nodes comprises defining at least one of a deferred choice pattern and a milestone pattern.

7. The method according to claim 1, wherein defining the at least one of the nodes comprises defining a loop in the workflow comprising a conditional XOR-Split having a condition associated therewith, and wherein performing the action comprises applying the CEP engine to determine whether to repeat or exit the loop responsively to the condition.

8. The method according to claim 1, wherein defining the at least one of the nodes comprises defining the situation as a composition of multiple subsidiary situations, each of which triggers a corresponding action, and wherein performing the action comprises detecting one of the subsidiary situations using the CEP engine, and triggering the corresponding action.

9. Apparatus for workflow management, comprising:
a modeling station, which is arranged to model a workflow as a set of nodes linked by transitions, in which at least one of the nodes is defined as an action triggered by a situation using a complex event processing (CEP) engine; and
a workflow server, which is arranged to execute the workflow while invoking the CEP engine in order to detect the situation, and to cause the action to be performed responsively to detection of the situation by the CEP engine.

10. The apparatus according to claim 9, wherein the modeling station is arranged to model the at least one of the nodes as a complex pattern comprising a scenario involving a set of activities and the transitions among the set of the activities.

11. The apparatus according to claim 10, wherein the modeling station is arranged to change the pattern, using the CEP engine, during execution of the workflow.

12. The apparatus according to claim 9, wherein the modeling station is arranged to define a lifespan of the situation comprising initiating and terminating events and a condition for triggering the action during the lifespan.

13. The apparatus according to claim 12, wherein the workflow server is arranged to detect the initiating event and to trigger the action using the CEP engine if the condition is fulfilled during the lifespan.

14. The apparatus according to claim 13, wherein the modeling station is arranged to define the at least one of the nodes as at least one of a deferred choice pattern and a milestone pattern.

15. The apparatus according to claim 9, wherein the modeling station is arranged to define the at least one of the nodes as a loop in the workflow comprising a conditional XOR-Split having a condition associated therewith, and wherein the workflow server is arranged to apply the CEP engine to determine whether to repeat or exit the loop responsively to the condition.

16. The apparatus according to claim 9, wherein the modeling station is arranged to define the situation as a composition of multiple subsidiary situations, each of which triggers a corresponding action, and wherein the workflow server is arranged to detect one of the subsidiary situations using the CEP engine, and to trigger the corresponding action.

17. A computer software product for workflow management, the product comprising a computer-readable medium in which program instructions are stored, which instructions, when read by a computer, cause the computer to model a workflow as a set of nodes linked by transitions, in which at least one of the nodes is defined as an action triggered by a situation using a complex event processing (CEP) engine, and to execute the workflow while invoking the CEP engine in order to detect the situation, and to cause the action to be performed responsively to detection of the situation by the CEP engine.

18. The product according to claim 17, wherein the instructions cause the computer to model the at least one of the nodes as a complex pattern comprising a scenario involving a set of activities and the transitions among the set of the activities.

19. The product according to claim 18, wherein the instructions cause the computer to change the pattern, using the CEP engine, during execution of the workflow.

20. The product according to claim 17, wherein the instructions cause the computer to define a lifespan of the situation comprising initiating and terminating events and a condition for triggering the action during the lifespan.

21. The product according to claim 20, wherein the instructions cause the computer to detect the initiating event and to trigger the action using the CEP engine if the condition is fulfilled during the lifespan.

22. The product according to claim 21, wherein the instructions cause the computer to define the at least one of the nodes as at least one of a deferred choice pattern and a milestone pattern.

23. The product according to claim 17, wherein the instructions cause the computer to define the at least one of the nodes as a loop in the workflow comprising a conditional XOR-Split having a condition associated therewith, and to apply the CEP engine to determine whether to repeat or exit the loop responsively to the condition.

24. The product according to claim 17, wherein the instructions cause the computer to define the situation as a composition of multiple subsidiary situations, each of which triggers a corresponding action, and to detect one of the subsidiary situations using the CEP engine, and to trigger the corresponding action.
